(19) United States
(12) Patent Application Publication
(10) Pub. No.: US 2011/0179436 A1
(43) Pub. Date: Jul. 21, 2011

(54) PARENTAL CONTROL FOR A MIXED VIEWING AUDIENCE USING SHUTTER GLASSES

(75) Inventor: Brant L. Candelore, San Diego, CA (US)

(73) Assignees: SONY CORPORATION, Tokyo (JP); SONY ELECTRONICS INC., Park Ridge, NJ (US)

(21) Appl. No.: 12/688,681

(22) Filed: Jan. 15, 2010

(51) Int. Cl. H04N 7/16

(52) U.S. Cl. 725/25

(57) ABSTRACT

According to one embodiment, a system for implementing parental control using a plurality of pairs of shutter glasses comprises a digital device and a first and second pair of shutter glasses. The digital device includes a tuner/demodulator unit, a data processing unit and a transmitter. The tuner/demodulator unit receives content being a scene of a program. The data processing unit decodes the scene during playback which includes determining if the scene includes objectionable content that exceeds the plurality of preset ratings on a scene-by-scene basis. If the data processing unit determines that the scene includes objectionable content that exceeds the first preset rating, the transmitter sends a first synchronization signal that identifies the objectionable content to the first pair of shutter glasses, and if the data processing unit determines that the scene includes objectionable content that exceeds the second preset rating, the transmitter sends the second synchronization signal that identifies the objectionable content to the second pair of shutter glasses. The first pair of shutters blocks objectionable content based on the first synchronization signal received from the first receiver and the second pair of shutters block the objectionable content based on the second synchronization signal received from the second receiver.

### BACKGROUND

### FIELD

Embodiments of the invention relate to parental control of digital content. More specifically, one embodiment of the invention relates to a system and method for blocking unwanted content on a scene-by-scene basis using shutter glasses.

### BACKGROUND

In an effort to mitigate children's exposure to objectionable content, parents are forced to watch and listen to the content being watched by their children. Objectionable content includes for example violence, sexual situations, indecent or suggestive language.

Currently, with respect to the rendering of video programs, televisions are implemented with a V-chip, which may be set by parents to preclude the playback of programs that exceed a selected age-based rating. A black screen is shown for any program that exceeds the selected age-based rating in order to prevent such viewing. This program blocking can be disabled with a parental password.

There are a number of major shortcomings of the V-chip. For instance, the V-chip filters only at the program level, namely a viewer gets to view the entire program or nothing at all. In other words, there are no intermediate levels of blocking, which prevents the playback of certain programs that would be appropriate and perhaps educational for children if certain images or audio were eliminated. Also, how programs are rated is still a subjective task, and the assigned ratings may not be consistent with the views of certain parents. As an example, some programs with violence or drug use may receive a lower rating than programs with indecent language, but certain parents might consider violence to be more objectionable.

In addition, it is known to use the shutter glasses system to create the illusion of a three-dimensional image being displayed. The shutter glasses produce the three-dimensional effect by closing the left and right liquid crystal (LC) shutters in the glasses in an alternate fashion. More specifically, in traditional systems, the shutter glasses receive a synchronization signal which causes the left and right LC shutters to alternately switch from being opaque to transparent and from being transparent to opaque. When opaque, the viewer cannot see through the shutter. Accordingly, only one eye can see the displayed image at any given time. However, given the persistence of the human eye which results in both eyes seeing their corresponding images simultaneously, the shutter glasses allow the viewer to view the displayed image in a stereoscopic sense.

### SUMMARY

Embodiments of systems and methods for implementing parental control using a plurality of pairs of shutter glasses are described.

Accordingly to one embodiment, a user may pre-establish parental control ratings or preset ratings to each of the pairs of shutter glasses. A first and a second preset rating may be set for the first and second pair of shutter glasses, respectively, and the first preset rating may be different from the second preset rating. In this embodiment, a system for implementing parental control using a plurality of pairs of shutter glasses comprises a digital device and a first and second pair of shutter glasses.

The digital device includes a tuner/demodulator unit, a data processing unit and a transmitter. The tuner/demodulator unit receives content being a scene of a program. The data processing unit decodes the scene during playback which includes determining if the scene includes objectionable content that exceeds the plurality of preset ratings on a scene-by-scene basis. If the data processing unit determines that the scene includes objectionable content that exceeds the first preset rating, the transmitter sends a first synchronization signal that identifies the objectionable content to the first pair of shutter glasses, and if the data processing unit determines that the scene includes objectionable content that exceeds the second preset rating, the transmitter sends the second synchronization signal that identifies the objectionable content to the second pair of shutter glasses. In one embodiment, the data processing unit determines a context of the objectionable content if the scene of the program is determined to include objectionable content and further determines that the scene does not include objectionable content if the objectionable content fails to arise to a predetermined level in light of the context.

Each of the pairs of shutter glasses includes a receiver and a pair of shutters. The receivers included in the first and second pair of shutter glasses receive the first and second synchronization signals, respectively. Accordingly, the first pair of shutters blocks objectionable content based on the first synchronization signal received from the first receiver and the second pair of shutters block the objectionable content based on the second synchronization signal received from the second receiver. Each of the pairs of shutter glasses may also include earphones that mute the audio content corresponding to the objectionable content being blocked by the pair of shutter glasses.

Given the first preset rating may be different from the second preset rating, the first pair of shutter glasses displays the objectionable content being blocked by the second pair of shutter glasses if the first preset rating is lower than the second preset rating.

Additionally, in another embodiment, the data processing unit further includes a substitution unit for substituting the objectionable content with a replacement content, wherein the replacement content is content of a lower rating than the preset rating. The replacement content may be downloaded from a content provider or may be included in the content received by the digital device.

In one embodiment, the replacement content may be content of a higher rating than that of the objectionable content. For example, if the first preset rating indicates that up-rating is desired and the second preset rating indicates that down-rating is desired, the substitution unit substitutes the content with a replacement content of a higher rating for the first pair of shutter glasses and substitutes the content with a replacement content of a lower rating for the second pair of shutter glasses. In this embodiment, the first synchronization signal causes the first pair of shutters to synchronize with the replacement content of a higher rating while the second synchronization signal causes the second pair of shutters to synchronize with the replacement content of a lower rating.

In yet another embodiment, a method for implementing parental control on a scene-by-scene basis on a plurality of pairs of shutter glasses starts by receiving incoming content including content being a scene of a program and the scene is decoded during playback. Decoding the scene includes determining if the scene of the program includes objectionable content by accessing control information provided with the content and comparing the control information with preset ratings on a scene-by-scene basis. Decoding the scene further includes sending a plurality of synchronization signals to the plurality of pairs of shutter glasses, respectively. If the scene is determined to include objectionable content that exceeds a first preset rating, the first synchronization signal identifies the objectionable content and causes the first pair of shutter glasses to block the objectionable content from being viewed. Similarly, if the scene is determined to include objectionable content that exceeds a second preset rating, the second synchronization signal identifies the objectionable content and causes the second pair of shutter glasses to block the objectionable content from being viewed.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is an exemplary block diagram of a system consistent with certain embodiments of the invention.

FIG. 2 is an exemplary diagram of a content filter unit implemented within the digital device according to one embodiment of the invention.

FIG. 3 is an exemplary diagram of pair of shutter glasses according to one embodiment of the invention.

FIG. 4 is an illustrative flowchart of a method consistent with certain embodiments of the invention.

FIG. 5 is an illustrative flowchart of a process for determining whether content being a scene of a program includes objectionable content.

FIG. 6 is an illustrative flowchart of a process for blocking content being a scene of a program based on parental control parameters.

FIG. 7 is an exemplary embodiment of an Age-based Rating scheme for blocking of a scene of a program including objectionable content.

FIG. 8 is an exemplary embodiment of a Content-based Rating scheme for blocking of scenes including objectionable content.

FIGS. 9 and 10 are exemplary embodiments of a Tag Rating scheme for blocking of scenes including objectionable content.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

For purposes of the present description, the term “digital device” may refer to a television that is adapted to tune, receive, decrypt, descramble and/or decode transmissions from any content provider. Examples of “content providers” may include a terrestrial broadcaster, a cable or satellite television distribution system, or a company providing content for download over the Internet or other Internet Protocol (IP) based networks like an Internet service provider. However, it is contemplated that the digital device may be of another form factor besides a television, such as a set-top box, a personal digital assistant (PDA), a computer, a cellular telephone, a video game console, a portable video player such as a SONY® PSP® player or an APPLE® video iPOD™, a digital video recorder, or the like.

In the following description, certain terminology is used to describe features of the invention. For example, in certain situations, the terms “component,” “unit” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a floppy diskette, an optical disk (e.g., compact disk or digital video disc “DVD”), a hard drive disk, a tape, or the like.

In addition, the term “program” generally represents a stream of digital content that is configured for transmission to one or more digital devices for viewing and/or listening. According to one embodiment, the program may contain MPEG (Moving Pictures Expert Group) compliant compressed video. The “scene” may be generally defined as one or more frames of content, namely one or more frames video, one or more still images, or any combination thereof. For instance, as an example, a scene may include fifteen (15) consecutive frames of video.

Certain types of content, such as movies, have an associated content rating established by a supervisory body to inform potential viewers of the type of material that may form a part of the content. General ratings of G, PG, PG-13, R and NC-17 are commonly established for most movies produced in the United States by the Classification and Ratings Administration (CARA) of the Motion Picture Association (MPA) or the Motion Picture Association of America (MPAA). Television programming is similarly rated by the TV Parental Guidelines Monitoring Board, which provides ratings of TV-Y, TV-Y7, TV-Y7-FV, TV-G, TV-14 and TV-MA.

For purposes of this document, content having a rating provided under such rating systems will be referred to as having a “higher” rating if it is intended for more mature audiences, and a “lower” rating if it is intended for a more general or less mature audience. Hence, the previously described rating systems are listed from lowest to highest. Therefore, within this terminology, an R rating would be considered a “higher” rating than a G rating. Such nomenclature is defined herein for simplicity of description of the above rating system as well as equivalent systems, without intent for the nomenclature to pass any judgment on the quality of such content.

Additionally, the term “rating” is intended to embrace any suitable content rating system, domestic or foreign, public, private or even governmental that is formed to serve a similar function, but applied on a scene-by-scene basis. Such rating information may be added to content information included in a compressed video packet such as a MPEG compliant packet. As an alternative to (or in combination with) the rating information, tag information that identifies the particular subject matter of the scene may be added to the content information.

While this invention is susceptible to embodiments of many different forms, there is shown in the drawings and will herein be described in detail specific embodiments, with the understanding that the present disclosure is to be considered as an example of the principles of the invention and not intended to limit the invention to the specific embodiments shown and described.

I. General Architecture

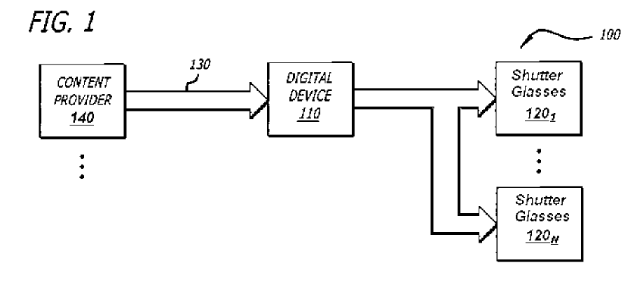

Referring to FIG. 1, an exemplary block diagram of a system 100 consistent with certain embodiments of the invention is shown. The system 100 comprises a digital device 110, one or more content providers 140 and multiple pairs of shutter glasses 120₁-120_{N} (where N≧2).

The digital device 110 receives digital content such as a program from one or more content providers 140. The program may be propagated as a digital data stream for example in compliance with any data compression scheme. Examples of a data compression scheme include, but are not limited or restricted to MPEG standards.

According to one embodiment of the invention, digital device 110 decodes an incoming program, and evaluates the content of the incoming program on a scene-by-scene basis. Such evaluation is performed using content information included in the digital content in order to determine whether such scenes include any objectionable content. The content information included in the digital content may includes ratings of a scene of content, tags identifying the type of content within the scene or a combination thereof. Illustrative evaluation schemes are described below. The term “objectionable content” means that the content features certain subject matter that may be inappropriate for the targeted viewing or listening audience at this time.

According to another embodiment of the invention, the content information may include closed captioning (CC) information such that the evaluation may involve analysis of the closed captioning (CC) information to obtain clues or hints that the content for display might include objectionable content.

The digital device 110 sends a plurality of synchronization signals to the plurality of pairs of shutter glasses 120₁-120_{N}, respectively. For example, a first synchronization signal sent to a first pair of shutter glasses 120₁ causes the first pair of shutter glasses 120₁ to block the content that exceeds the first preset rating while a second synchronization signal sent to a second pair of shutter glasses 120_{N} (N=2) causes the second pair of shutter glasses 120₂ to block the content that exceeds the second preset rating. As discussed further below, the digital device 100 may include a transmitter such as an Infrared (IR) transmitter or a Bluetooth transmitter which sends the plurality of synchronization signals. Each of the pairs of shutter glasses 120₁-120_{N} receives the plurality of synchronization signals, respectively, via a receiver such as an IR receiver or a Bluetooth receiver.

Content provider 120 provides the digital content to digital device 110 through transmission medium 130, which operates as a communication pathway for the program within content delivery system 100. The content may include one or more frames of video and/or audio associated with the scene of the program. The transmission medium 130 may include, but is not limited to electrical wires, optical fiber, cable, a wireless link established by wireless signaling circuitry, or the like.

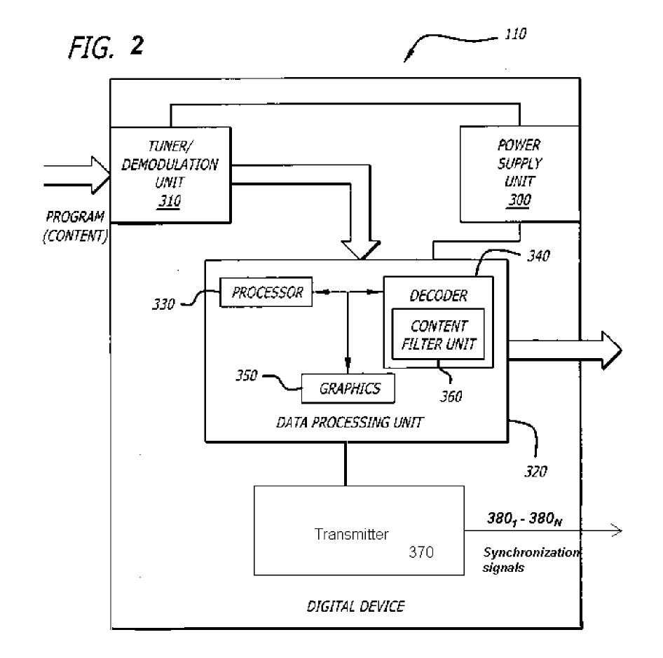

Referring now to FIG. 2, an exemplary diagram of digital device 110 of the system 100 is shown. Digital device 110 comprises a power supply unit 300, a tuner/demodulation unit 310, data processing unit 320, and a transmitter 370. Power supply unit 300 is adapted to provide powered to tuner/demodulation unit 310 and data processing unit 320. Power supply unit 300 may provide regulated power based on input power received from a power supply such as a wall socket (e.g., 110 volts alternating current “VAC”, 220 VAC, etc.), or power connector within a car, or the like. Tuner/demodulation unit 310 tunes to a channel to receive the program and demodulates an incoming program to recover the content. Then, the content is routed as a digital bit stream to data processing unit 320.

Data processing unit 320 comprises a processor 330 (e.g., central processing unit), a decoder 340 and a graphics component 350. These components may be implemented as separate integrated circuits or as a single integrated circuit (system-on-chip implementation) as shown.

According to one embodiment of the invention, decoder 340 is implemented with a content filter unit 360 that is adapted to decode the content during playback of video and/or audio. In general, according to one embodiment of the invention, content filter unit 360 is designed to render the video or to cause the blocking display of the video based on findings by processor 330, which accesses the content information used to evaluate whether a scene has objectionable content.

According to one embodiment, processor 330 is adapted to process the content information such as, for example, the closed captioning and emergency alert system (EAS) data as well as guide data. Hence, processor 330 may be adapted to access the content information in the Picture User Data of incoming MPEG packets in order to provide signaling to content filter unit 360 regarding the rating or subject matter within each upcoming scene of the incoming content before such content is displayed. This allows content filter unit 360 to determine whether the subject matter constitutes objectionable content. In one embodiment, the content filter unit 360 compares the control information to a plurality of preset ratings corresponding to a plurality of shutter glasses, respectively. For example, a first and a second preset rating may be set for the first and second pair of shutter glasses, respectively.

In one embodiment, if the scene of the program is determined to include objectionable content, the content filter unit 360 further determines a context of the objectionable content. If the objectionable content fails to arise to a predetermined level in light of the context of the objectionable content, the content filter unit 360 determines that the scene does not include objectionable content.

Of course, it is contemplated that decoder 340 may be adapted to access the content information itself. Moreover, as an alternative embodiment, decoder 340 may be adapted to separate certain types of data, such as closed captioning or EAS data for processing by processor 330.

Graphics component 350 is adapted for rendering on-screen menus or guide data. For instance, processor 330 may be adapted to collect guide data and for storage of such guide data in local memory (not shown). When such data is requested, it is displayed by graphics component 350, which would overlay video concurrently displayed. Also, graphics component 350 may be adapted to distort or blank out (block) displayed images.

Transmitter 370, being a transceiver such as an IR transmitter or a Bluetooth transmitter, is coupled to the data processing unit 320 and adapted for transmitting a plurality of synchronization signals 380₁-380_{N} to each of the plurality of pairs of shutter glasses 120₁-120_{N}, respectively. For example, if the data processing unit 320 determines that the subject matter constitutes objectionable content that exceeds a first preset rating, the transmitter 370 sends a first synchronization signal that identifies the objectionable content and causes the first pair of shutter glasses 120₁ to block the objectionable content.

Additionally, the first preset rating may be different from the second preset rating such that, when viewing the same program, the first and second pair of shutter glasses allow viewing of different content based on the respective preset ratings. For example, if the first preset rating is lower than the second preset rating, the first pair of shutter glasses may permit viewing of a scene rated R while the second pair of shutter glasses may block scenes rated PG.

In one embodiment, the data processing unit further includes a substitution unit. If the scene is determined to include objectionable content, the substitution unit substitutes the objectionable content with a replacement content that is content a lower rating that the preset rating. The replacement content may be included in the content received by the digital device or may be downloaded from a content provider.

In another embodiment, the replacement content may be content of a higher rating than that of the objectionable content. For example, if the first preset rating indicates that up-rating is desired and the second preset rating indicates that down-rating is desired, the substitution unit substitutes the content with a replacement content of a higher rating for the first pair of shutter glasses and substitutes the content with a replacement content of a lower rating for the second pair of shutter glasses. In this embodiment, the first synchronization signal causes the first pair of shutters to synchronize with the replacement content of a higher rating while the second synchronization signal causes the second pair of shutters to synchronize with the replacement content of a lower rating.

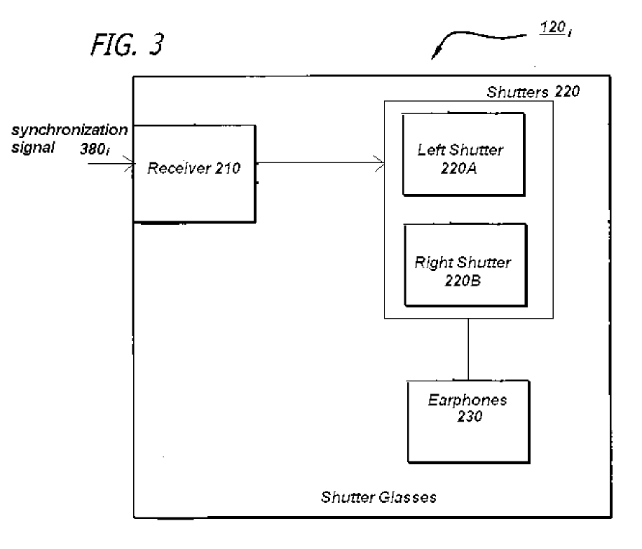

Referring now to FIG. 3, an exemplary diagram of a pair of shutter glasses 120ᵢ (1≦i≦N) of the system 100 is shown. The pair of shutter glasses 120ᵢ comprises a receiver 210 and a pair of shutters 220A, 220B. The receiver 210, being a receiver such as an IR receiver or Bluetooth receiver, receives a corresponding synchronization signal 380, (1≦i≦N) from transmitter 370. The synchronization signal 380ᵢ is one of the plurality of synchronization signals 380ᵢ (1≦i≦N).

The pair of shutters 220A, 220B including a left shutter 220A and a right shutter 220B, can be rapidly switched between an opaque (“closed”) and transparent (“open”) state. When, for example, the left shutter 220A is opaque or closed, the left eye cannot view the image being displayed whereas when the left shutter is transparent or open, the left eye views the image being displayed.

In conventional shutter glasses used for viewing three-dimensional displays, the left shutter 220A and the right shutter 220B are operated alternatively such that only one eye can see the displayed image at any given time because the left and right images are frame sequential. Accordingly, in one embodiment of the present invention, the left and right shutters 220A, 220B are operated alternatively in order to block the objectionable three-dimensional content.

In another embodiment of the present invention, when viewing two-dimensional content, the left and right shutters 220A, 220B are being operated simultaneously such that both shutters are either open or closed. More specifically, both the left and right shutters 220A, 220B would remain open in order to view the two-dimensional content and both the left and right shutters 220A, 220B would close simultaneously in order to block the objectionable two-dimensional content from being viewed.

In each pair of shutter glasses 120ᵢ, the shutters 220A,220B are coupled to the receiver 210 and blocks the objectionable content based on synchronization signal 380ᵢ (1≦i≦N). For example, the first synchronization signal 380₁ synchronizes the operation of the shutters 220A, 220B for the first pair of shutter glasses 120₁. In other words, the first synchronization signal 380₁ regulates the opening and closing of the shutters 220A, 220B of the first pair of shutter glasses 120₁ in such a way that the shutters 220A, 220B close when the objectionable content that exceeds the first present rating is being displayed on the digital device 110. In this manner, the shutters 220A, 220B block the objectionable content from being viewed.

In one embodiment, the pair of shutter glasses 120, may further comprise one or more earphones 230. The earphones 230 may mute the audio content corresponding to the objectionable content being blocked.

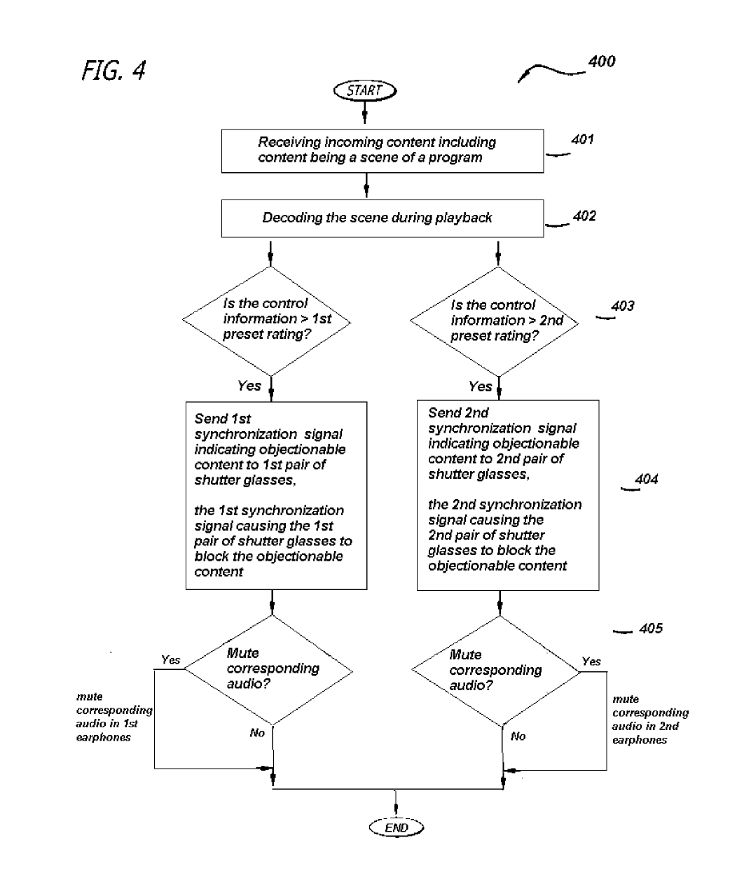

Referring now to FIG. 4, an illustrative flowchart of a method for implementing parental control on a scene-by-scene basis on a plurality of pairs of shutter glasses is illustrated. Method 400 begins by receiving incoming content including content being a scene of a program (Block 401). The content may be sent from a content provider and received by the digital device. In some embodiments, the content may include one or more frames of video and/or audio associated with the scene of the program.

At block 402, the digital device decodes the scene during playback. The decoding of the scene includes determining if the scene of the program includes objectionable content by determining if the scene of the program includes objectionable content by accessing control information provided with the content and comparing the control information with a plurality of preset ratings on a scene-by-scene basis (Block 403).

The plurality of preset ratings may include a first and a second preset rating. The first preset rating may be different from the second preset rating. In one embodiment of the invention, each of the plurality of pairs of shutter glasses correspond to each of the plurality of preset ratings. Accordingly, the first preset rating may be applied to the first pair of shutter glasses while the second preset rating may be applied to the second pair of shutter glasses.

The decoding of the scene may further include sending a plurality of synchronization signals to the plurality of pairs of shutter glasses, respectively (Block 404). For example, the plurality of synchronization signals may include a first and a second synchronization signal. If the scene is determined to include objectionable content that exceeds the first preset rating at Block 403, the first synchronization signal identifying the objectionable content causes the first pair of shutter glasses to block the objectionable content from being viewed (Block 404). Similarly, if the scene is determined to include objectionable content that exceeds the second preset rating at Block 403, the second synchronization signal identifying the objectionable content and causes the second pair of shutter glasses to block the objectionable content from being viewed (Block 404).

As above, the first and second synchronization signals cause the first and second pair of shutters glasses, respectively, to switch from being opaque to transparent or from being transparent to opaque. When the shutters are opaque, the shutter glasses prevent images from being viewed by the user (i.e., the images are blocked).

The first and second pairs of shutter glasses receive the first and second synchronization signals, respectively, and regulate the opening and closing of their shutters accordingly. In one embodiment, the first synchronization signal causes the first pair of shutter glasses to become opaque to block objectionable content that exceeds a first preset rating. Similarly, the second synchronization signal causes the second pair of shutter glasses to become opaque to block objectionable content that exceeds a second preset rating.

Additionally, method 400 may further comprise muting an audio content corresponding to the objectionable content being blocked by the first pair of shutter glasses and muting an audio content corresponding to the objectionable content being blocked by the second pair of shutter glasses (Block 405). Accordingly, a first viewer using the first pair of shutter glasses would be prevented from hearing the audio content corresponding to the objectionable content being blocked by the first pair of shutter glasses while a second viewer using the second pair of shutter glasses would be prevented from hearing the audio content corresponding to the objectionable content being blocked by the second pair of shutter glasses.

In one embodiment, if the scene of the program is determined to include objectionable content, the digital device may further determine a context of the objectionable content. The digital device may then determine that the scene does not include objectionable content because the objectionable content fails to arise to a predetermined level in light of the context of the objectionable content.

In one embodiment, if the scene is determined to include objectionable content, the digital device may substitute the content with a replacement content that is content of a lower rating than the preset rating.

In the event where the first preset rating indicates that up-rating is desired and the second preset rating indicates that down-rating is desired, in one embodiment, the digital device substitutes the content with a replacement content of a higher rating for the first pair of shutter glasses and substitutes the content with a replacement content of a lower rating for the second pair of shutter glasses. In this embodiment, the first pair of shutter glasses is synchronized with the replacement content of a higher rating using the first synchronization signal and the second pair of shutter glasses is synchronized with the replacement content of lower rating using the second synchronization signal. Accordingly, the first pair of shutter glasses allows viewing of a content of a higher rating than the second pair of shutter glasses.

II. Content Blocking Techniques

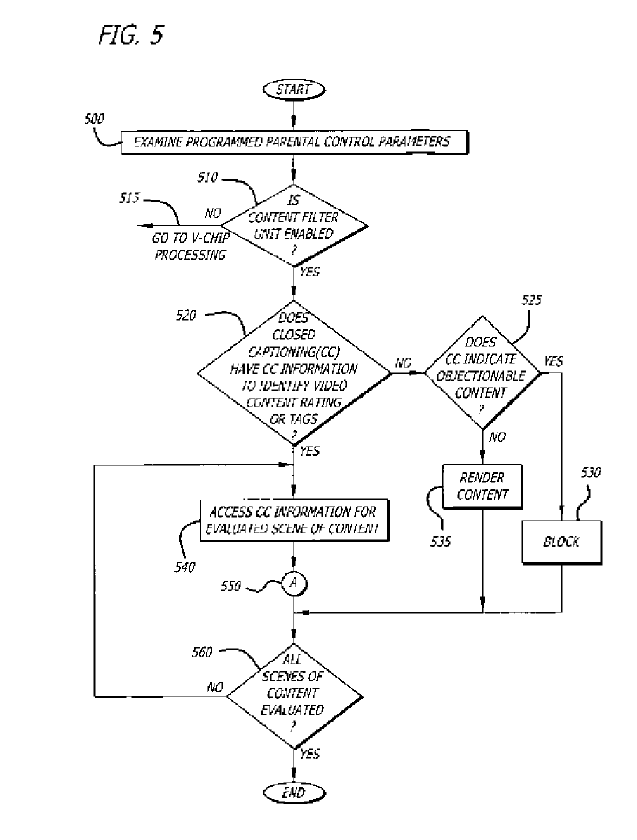

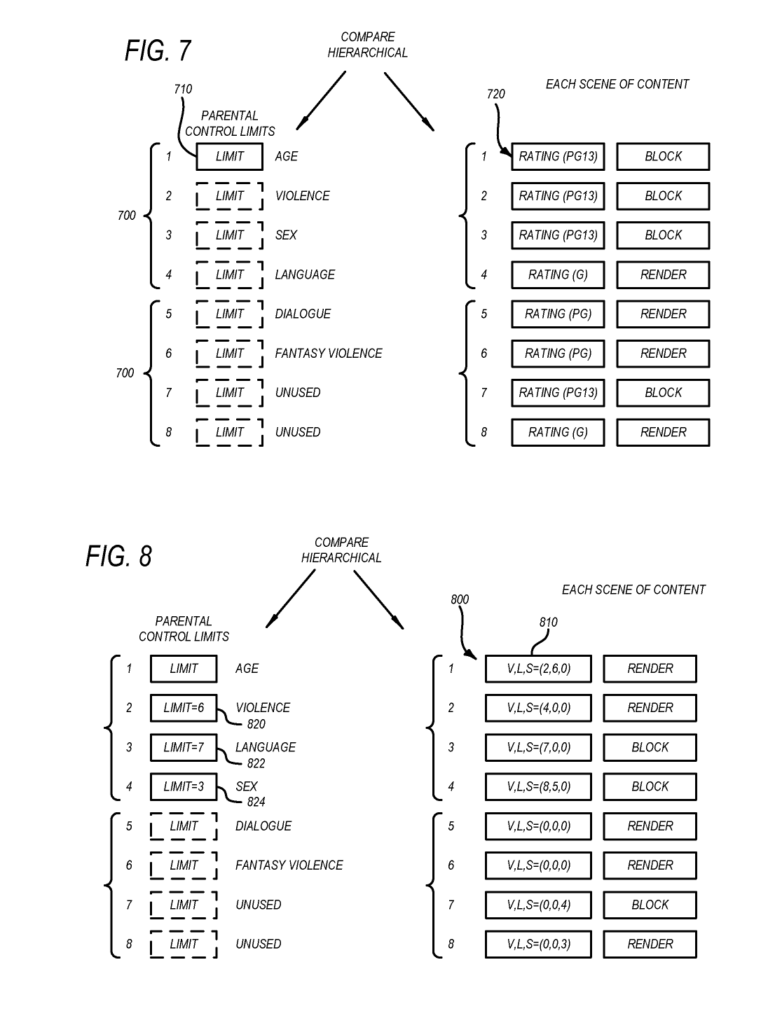

Referring now to FIG. 5, an illustrative flowchart of a process for determining whether content associated with a program should be prevented from being displayed is shown. As illustrated, initially programmed parental control parameters are examined to determine what constitutes “objectionable content” for this content filter unit (block 500). The parental control parameters (or preset ratings) are preset as shown in FIGS. 7-10.

Next, a determination is made whether the content filter unit has been enabled (block 510). If not, the V-chip is used as an alternative source for regulating the content to be viewed (arrow 515). If the content filter unit has been enabled, a first evaluation is whether the program being transmitted features closed captioning (CC) information that identifies the rating (e.g., age or content based) or type of content (e.g., tags) for an incoming scene (block 520).

For each scene, a portion of the incoming content, such as the User Picture Data field for example, is accessed to retrieve closed captioning information therefrom. If the closed captioning information does not feature information to identify rating or type of content, as an alternative, the closed captioning information itself may be used to provide hints regarding upcoming scenes (block 525). For instance, certain descriptions of noises and spoken dialogue may be used to suggest a sexual or violent situation in an upcoming scene. Upon detection, the scene is blocked where the displayed content is completely or partially blocked from view (block 530). Otherwise, the content is rendered for display without filtering (block 535).

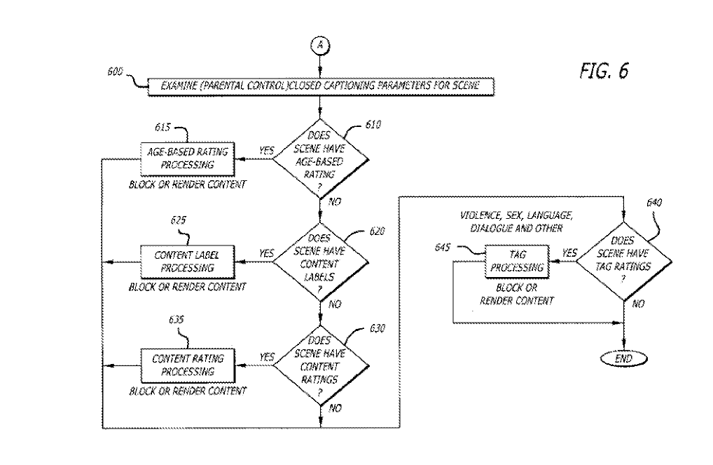

In the event that the closed captioning information includes information to identify rating or type of content, such information is accessed to evaluate the upcoming scene of content (block 540) to determine whether the incoming content should be blocked (block 550), and thereafter, continuing this process for each scene (block 560). The blocking scheme is set forth in FIG. 6.

FIG. 6 provides an illustrative flowchart of a process for blocking content based on parental control parameters. Initially, as shown in block 600, parental control parameters associated with the scene are examined. Next, a determination is made whether the display of the scene is controlled based on an Age Rating (block 610). If so, Age-based rating processing is conducted where the Age Rating of the scene is compared to Aged-based parental control limits programmed by the end user and monitored by the content filter unit (block 615). In the event that the Age Rating of the scene exceeds the Aged-based parental control limits, the scene is not rendered, but instead may partially or completely blocked.

For instance, as shown in FIG. 7, an exemplary ratings table 700 for objectionable content is shown. Herein, the content filter unit is programmed by setting an Age-based parental control limit within a first parental control parameter 710. As an example, the Age Rating is established to cover age-based rating levels G, PG, PG-13, R and NC-17 ratings used in movies as well as rating levels TV-Y, TV-Y7, TV-Y7-FV, TV-G, TV-14 and TV-MA used in television broadcasts. For instance, TV-14 may have the same Age rating level as PG-13 (V,S), where “V” denotes violence and “S” denotes sexual content.

As an illustrative example, a first scene 720 of a program may feature “PG-13” rated content, which is blocked if the Aged-based parental control limit is set to “PG”. As a result, for “PG” Aged-based parental control limits set within first parental control parameter 710, content for scenes 4-6 and 8 would be rendered. However, content for scenes 1-3 and 7 would be blocked since the closed captioning information identifies that these scenes having a rating that exceeds “PG” Aged-based limits

Referring back to FIG. 6, another determination is whether the display of the scene is controlled based on content label scheme (blocks 620 and 625). With respect to content label evaluation scheme, a determination is made if any particular category of content is present. This is similar to Content Rating scheme describe below where the “Intensity” parental control limits are set to “0”, which also indicates that if there are any scenes having content with this subject matter, the scene is blocked.

Yet another determination is whether the display of the scene is controlled based on content rating scheme (block 630). If so, an Intensity rating is applied to a variety of subject matter categories that parents may find objectionable for their children (block 635). For instance, these categories may be broadly defined such as violence, sex, language, and the like. For the content that include this subject matter, “Intensity” values are assigned for each scene based on the maturity level of the subject matter.

As an illustrative example, as shown in FIG. 8, if a first scene 810 for incoming content 800 of a program includes a fist fight along with a curse word, the violence rating may be set to a first prescribed value, which will likely be fairly low (e.g., 2 out of 15). Depending on the curse word spoken and the audible nature of the curse word, the language rating may be set to a second prescribed value (e.g., 6 out of 15). Incoming content 800 is blocked if the parental control parameters for violence and language are less than “2” and “6”, respectively. Otherwise, the original content is shown since these Intensity values are less than or equal to the parental control limits of “6”, “7” and “3” for violence, sex and language parental control parameters 820, 822 and 824.

For these parent control limits, scenes 1, 5-6 and 8 of content 800 would be blocked while scenes 2-4 and 7 of content 800 would be rendered since the content associated with these scenes falls below the parental control limits selected. However, it is contemplated that the default setting can be configured to select the content having a rating closest to the parental control limits.

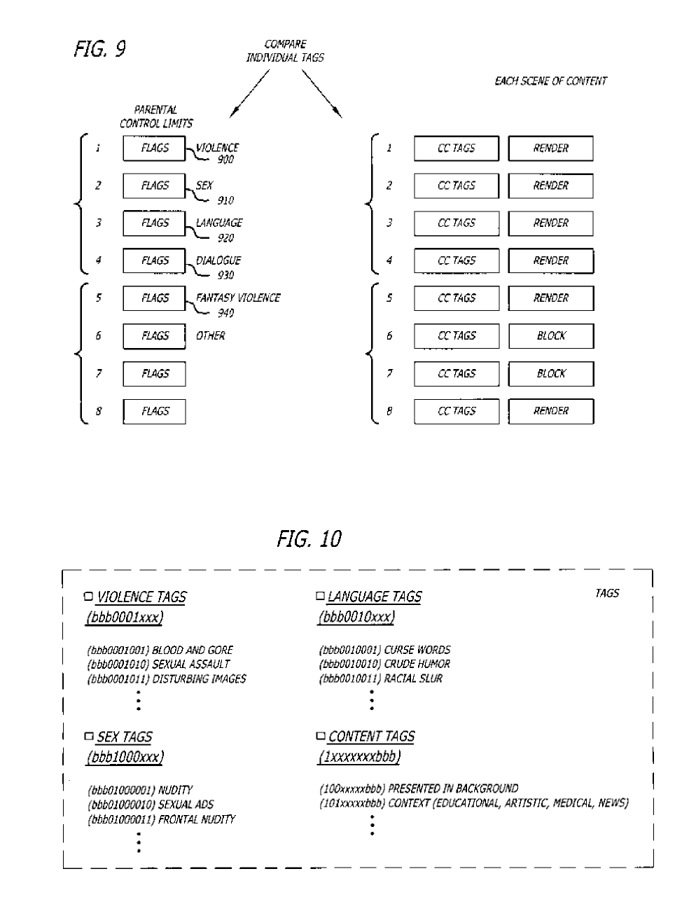

Referring back to FIG. 6, another determination is whether the display of the scene is controlled based on a tag rating scheme (blocks 640 and 645). As shown in FIGS. 9 and 10, the “tag rating” scheme provides a substantial granularity as to what specific content may be excluded. According to one embodiment, each category 900-940 and sub-category is uniquely assigned a unique bit pattern so that a 4-byte tag value associated with each scene may be used to identify multiple categories where potential objectionable content may be found. Hence, specific renderings of violence, language, sex, etc. may be prevented.

As an optional configuration, each category may be assigned a particular bit and sub-categories are identified by bit combinations inclusive of the bit assigned to the category. As an example, as shown in FIG. 10, a tag table may be created where a fourth least significant bit (bbb00001xxx) of a double word tag (4-bytes, where “b” denotes byte) is set when the scene involves violence. For the violence categories, a number of subcategories may be used to denote blood and gore (bbb00001001); sexual assault (bbb00001010), disturbing images (bbb00001011), etc.

Hence, for each scene, the tag is extracted from the closed captioning information and processed, such as conducting Exclusive OR'ed with the parent control parameter tags set by the user, in order to determine if any objectionable content is found in the scene. If not, the original content may be displayed. Otherwise, the content is blocked.

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are accordingly to be regarded in an illustrative rather than in a restrictive sense.

What is claimed is:

1. A system for implementing parental control using a plurality of pairs of shutter glasses, comprising:
a digital device to receive content being a scene of a program, the digital device including:
a data processing unit to decode the scene during playback, decoding the scene includes determining if the scene includes objectionable content that exceeds a plurality of preset ratings on a scene-by-scene basis, the plurality of preset ratings including a first and a second preset rating, the first preset rating being different from the second preset rating, and
a transmitter coupled to the data processing unit, the transmitter to send a plurality of synchronization signals, the plurality of control signals including a first and second synchronization signals, wherein
if the data processing unit determines that the scene includes objectionable content that exceeds the first preset rating, the first synchronization signal identifies the objectionable content, and
if the data processing unit determines that the scene includes objectionable content that exceeds the second preset rating, the second synchronization signal identifies the objectionable content; and
a plurality of pairs of shutter glasses including a first and a second pair of shutter glasses, each of the plurality of pairs of shutter glasses including:
a pair of shutters, a first pair of shutters is included in the first pair of shutter glasses and a second pair of shutters is included in the second pair of shutter glasses, the first pair of shutters blocking the objectionable content based on the first synchronization signal and the second pair of shutters blocking the objectionable content based on the second synchronization signal.

2. The system of claim 1, wherein the digital device further includes:
a tuner/demodulation unit being coupled to the data processing unit, the tuner/demodulation unit to receive the content being the scene of the program.

3. The system of claim 1, wherein each of the plurality of pairs of shutter glasses further includes a receiver coupled to the transmitter and the pair of shutters so that a first receiver is included in the first pair of shutter glasses and a second receiver is included in the second pair of shutter glasses, wherein:
the first receiver to receive the first synchronization signal and to transmit the first synchronization signal to the first pair of shutters, and the second receiver to receive the second synchronization signal and to transmit the second synchronization signal to the second pair of shutters.

4. The system of claim 1, wherein the plurality of pairs of shutter glasses further comprises:
one or more earphones, wherein
a first earphone is included in the first pair of shutter glasses, the first earphone muting an audio content corresponding to the objectionable content being blocked by the first pair of shutter glasses, and
a second earphone is included in the second pair of shutter glasses, the second earphone muting an audio content corresponding to the objectionable content being blocked by the second pair of shutter glasses.

5. The system of claim 1, wherein the first and second synchronization signals cause the first and second pair of shutters, respectively, to switch from being opaque to transparent or from being transparent to opaque, and wherein the first and second pair of shutter glasses, respectively, block objectionable content when the first and second pair of shutters are opaque.

6. The system of claim 5, wherein the first and second synchronization signals cause the first and second pairs of shutters, respectively, to operate alternatively to block objectionable three-dimensional content.

7. The system of claim 5, wherein the first and second synchronization signals cause the first and second pairs of shutters, respectively, to operate simultaneously to block objectionable two-dimensional content.

8. The system of claim 1, wherein the data processing unit includes a processor and a decoder coupled to the processor, the decoder to determine if the scene of the program includes objectionable content.

9. The system of claim 1, wherein the data processing unit determines if the scene includes objectionable content that exceeds a plurality of preset ratings by accessing control information provided with the main content and comparing the control information with the plurality of preset ratings.

10. The system of claim 9, wherein the data processing unit accessing control information includes accessing tag information that identifies one or more specific types of content found in the scene and the comparing of the control information with the plurality of preset ratings to determine if any of the specific types of content are found in the scene, the specific types of content are categorized and include (i) violence, (ii) sex and (iii) foul language.

11. The system of claim 9, wherein the data processing unit
accessing control information includes accessing intensity values assigned to subject matter found in the scene, the subject matter being directed to (i) violence, (ii) sex, (iii) language or (iv) any combination thereof, and
comparing the control information to the plurality of preset ratings includes determining if any of the intensity values exceed preset levels set for the subject matter that is permitted to be viewed.

12. The system of claim 1, wherein the content includes at least one of (i) one or more frames of video and (ii) audio associated with the scene of the program.

13. The system of claim 9, wherein the data processing unit comparing the information includes determining whether an Age-based rating assigned to the scene of the program associated with the content exceeds an Age-based parental control limit being the plurality of preset ratings.

14. The system of claim 1, wherein the data processing unit further
determines a context of the objectionable content if the scene of the program is determined to include objectionable content, and
determines that the scene does not include objectionable content if the objectionable content fails to arise to a predetermined level in light of the context of the objectionable content.

15. The system of claim 1, wherein the data processing unit further includes a substitution unit for substituting the content with a replacement content if the scene is determined to include objectionable content.

16. The system of claim 15, wherein the replacement content is downloaded from a content provider.

17. The system of claim 15, wherein the content includes the replacement content.

18. The system of claim 15, wherein, if the first preset rating indicates that up-rating is desired, the substitution unit substitutes the content with a replacement content of a higher rating.

19. The system of claim 15, wherein if the first preset rating indicates that up-rating is desired and the second preset rating indicates that down-rating is desired,
the substitution unit substitutes the content with a replacement content of a higher rating for the first pair of shutter glasses and substitutes the content with a replacement content of a lower rating for the second pair of shutter glasses, wherein the first synchronization signal causes the first pair of shutters to synchronize with the replacement content of a higher rating and the second synchronization signal causes the second pair of shutters to synchronize with the replacement content of a lower rating.

20. A method for implementing parental control on a scene-by-scene basis on a plurality of pairs of shutter glasses including a first and second pairs of shutter glasses, the method comprising:
receiving incoming content including content being a scene of a program; and
decoding the scene during playback, the decoding of the scene including:
(i) determining if the scene of the program includes objectionable content by accessing control information provided with the content and comparing the control information with a plurality of preset ratings on a scene-by-scene basis, the plurality of preset ratings including a first and a second preset rating, the first preset rating being different from the second preset rating,
(ii) sending a plurality of synchronization signals to the plurality of pairs of shutter glasses, respectively, the plurality of control signals including a first and second synchronization signals, wherein
if the scene is determined to include objectionable content that exceeds the first preset rating, the first synchronization signal identifies the objectionable content and causes the first pair of shutter glasses to block the objectionable content from being viewed, and
if the scene is determined to include objectionable content that exceeds the second preset rating, the second synchronization signal identifies the objectionable content and causes the second pair of shutter glasses to block the objectionable content from being viewed.
